(19) United States
(12) Patent Application Publication
(10) Pub. No.: US 2020/0160353 A1
(43) Pub. Date: May 21, 2020

(54) Anti-Counterfeiting System Using Near Field Communication (NFC) Tag

(71) Applicant: TUNG CHIN LIN, Nantou (TW)

(72) Inventors: TUNG CHIN LIN, Nantou (TW); CHUAN TUNG CHO, Taichung (TW)

(73) Assignee: Tung Chin Lin

(21) Appl. No.: 16/196,581

(22) Filed: Nov. 20, 2018

(51) Int. Cl. G06Q 30/00; G06K 19/07

(52) U.S. Cl. CPC G06Q 30/0185; G06K 19/0723

(57) ABSTRACT

An anti-counterfeiting system includes an NFC tag attached to a product, a mobile device capable of sensing the NFC tag, and a server receiving and transmitting signals from and to the mobile device. The mobile device reads verifying codes of the NFC tag and generates a location data by a GPS unit, and then transmits the verifying codes and the location data to the server. The server verifies the verifying codes and the location data, and then transmits a message back to the mobile device and shows the verifying result on a display of the mobile display.

### BACKGROUND OF THE INVENTION

### 1. Technical Field

The invention relates to an anti-counterfeiting system, and more particularly to an anti-counterfeiting system, which uses near field communication (NFC) and global positioning system (GPS) techniques.

### 2. Description of Related Art

In present days, more and more counterfeit products are sold in the market. In order to protect the consumers, some manufactures provide anti-counterfeiting labels to their products for identification. In early days, RFID is widely used in anti-counterfeiting technique. However, it needs a specific device to read the data in the RFID label, so that an ordinary consumer is unable to identify the RFID label by himself/herself

Taiwan Patent no. 1550545 taught a product certifying system, and Taiwan Patent no. 1536295 taught a security system of mobile electronic device and a method thereof. These two patents used near field communication (NFC) to sense and access data in an NFC tag and send the data to a cloud for the necessary processes. Since the NFC tags have good security, can be processed in the cloud, and the data in the NFC tags by a smartphone, the NFC tags are widely used in the modern anti-counterfeiting system.

However, the NFC tags may be duplicated by a suitable machine, which means counterfeiters may produce a fake NFC tag with the same data. It must be improved.

### BRIEF SUMMARY OF THE INVENTION

In view of the above, the primary objective of the present invention is to provide an anti-counterfeiting system, which has a high security in verifying the NFC tag to overcome the problems as described above.

In order to achieve the primary objective of the present invention, an anti-counterfeiting system includes a Near Field Communication (NFC) tag attached to a product, wherein the NFC tag is stored with two verifying codes; a mobile device having a processor, to which an NFC unit, a Global Positioning System (GPS) unit, a wireless transceiver, and a display are electrically connected, wherein the NFC unit reads the verifying codes of the NFC tag when the mobile device is close to the NFC tag; the GPS unit obtains a location data of the mobile device; and the wireless transceiver transmits the identification code, the encrypted code and the location data out; and a server stored with a plurality of code combinations, wherein the server receives the verifying codes and the location data from the mobile device, compares the verifying codes with the code combinations, and record the verifying codes and the location data.

The server transmits a message to the mobile device according to a comparison result of the verifying codes and the code combinations and a number of times of the verifying codes and the location data being recorded, and the mobile device shows the message on the display.

In an embodiment, the verifying codes include a identification code, which is an identification code, and a encrypted code, which is an encrypted code.

In an embodiment, the message transmitted to the mobile device from the server includes product information, traceability information, and a website address.

In an embodiment, the message indicates that the NFC tag is fake when no code combination is found the same as the verifying codes.

In an embodiment, the message indicates that the NFC tag is fake when a code combination is found the same as the verifying codes and the location data is different from the location data, which had been recorded in the server.

In an embodiment, the message indicates that the NFC tag is fake when a code combination is found the same as the verifying codes, the location data is the same as the location data, which had been recorded in the server, but the verifying codes and the location data had been recorded over a predetermined number of times.

In an embodiment, the number of times of the verifying codes and the location data being recorded is adjustable by a system administrator.

As a result, the sliders are moved to mesh the teeth row together or separate the teeth rows, and when the sliders are moved to separate the teeth rows and the sliders are move to the same side of the second case, the teeth rows have a section meshed together to become a hinge for opening and closing the second case.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a preferred embodiment of the present invention, showing the operation of the NFC tag;

FIG. 2 is a block diagram of the preferred embodiment of the present invention;

FIG. 3 is a flowchart of the preferred embodiment of the present invention; and

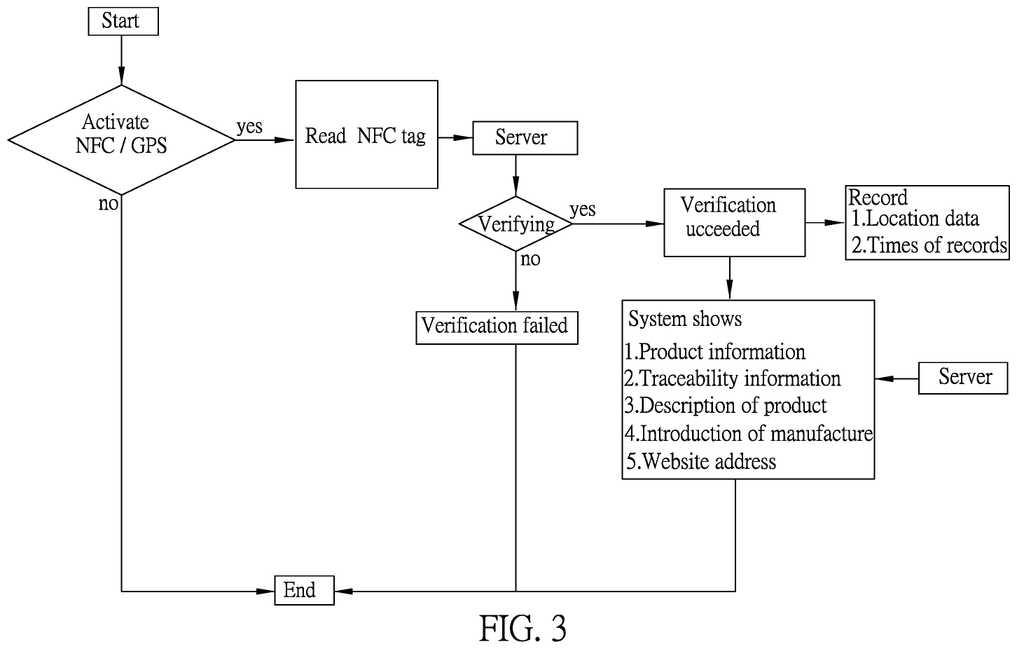

FIG. 4 is a flowchart of the preferred embodiment of the present invention, showing the identification of the fake tag.

### DETAILED DESCRIPTION OF THE INVENTION

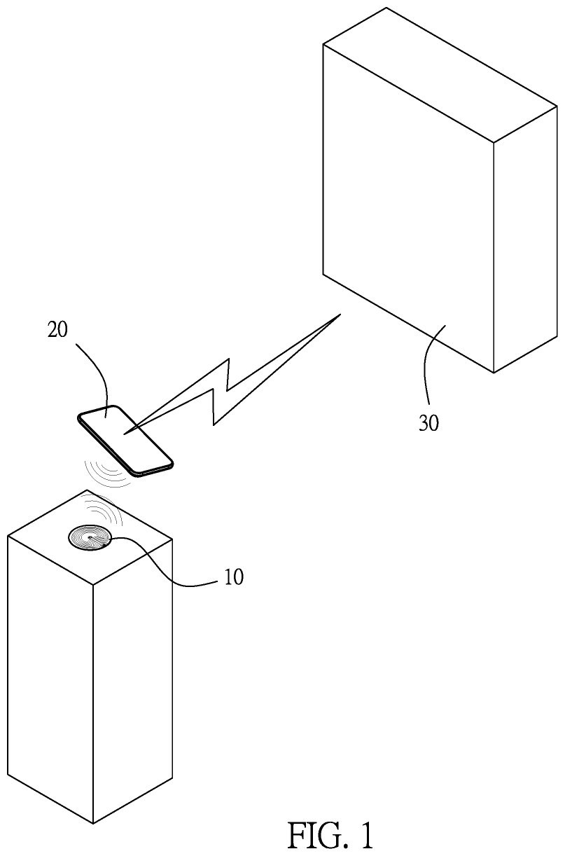

As shown in FIG. 1, an anti-counterfeiting system of the preferred embodiment of the present invention includes a Near Field Communication (NFC) tag 10, a mobile device 20, and a server 30. The NFC tag 10 is attached to a product 16. The mobile device 20 may sense the NFC tag 10 and read data in the NFC tag 10. The data read by the mobile device 20 will be sent to the server 30 for identification processes. The product may be anything that needs to be identified.

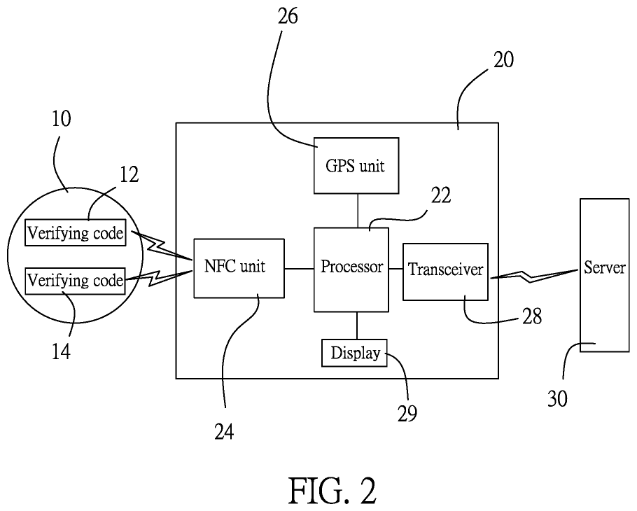

As shown in FIG. 2, the NFC tag 10 is stored with two verifying codes 12, 14, wherein the verifying codes 12, 14 includes an identification code 12, such as a serial number of chip, and an encrypted code 14, such as characters, numerals, symbols, or a combination of above. In the present embodiment, every NFC tag 10 has its own identification code 12, and the encrypted code 14 is generated by an algorithm according to the identification code 12. Therefore, the identification code 12 and the encrypted code 14 of every NFC tag 10 are unique.

The mobile device 20 includes a processor 22, to which an NFC unit 24, a Global Positioning System (GPS) unit 26, a wireless transceiver 28, and a display 29 are electrically connected. When the mobile device 20 is close to NFC tag 10 enough, the NFC unit 24 may read the verifying codes 12, 14 of the NFC tag 10.

The GPS unit 26 obtains a location data of the mobile device 20. Next, the wireless transceiver 28 sends the verifying codes 12, 14 and the location data to the server 30 via a network, such as internet.

The server 30 is stored with a plurality of code combinations 32, which include plural pairs of codes. When the server 30 received the verifying codes 12, 14 and the location data from the mobile device 20, the sever 30 compares the verifying codes 12, 14 with the code combinations 32 pre-stored in the server 30. A result of comparison will be sent back to the mobile device 20 and shown on the display 29.

Every time when the NFC tag 10 is sensed by the mobile device 20, the verifying codes 12, 14 and the location data will be sent to the server 30 and recorded in the server 30 as a sensing record. Therefore, any new arrived sensing result will be compared with the combinations 32 and the sensing records to check whether it is a fake tag or not.

A method of determining a fake NFC tag 10 includes the following steps:

Execute an application installed in the mobile device 20 to activate the NFC unit 24 and the GPS unit 26 of the mobile device 20. Next, move the mobile device 20 toward the NFC tag 10 until the NFC unit 24 senses the NFC tag 10 and obtains the verifying codes 12, 14 from the NFC tag 10. If the NFC unit 24 and the GPS unit 26 cannot be activated when the application is executing, or the application cannot be executed, it shows an error message on the display 29 of the mobile device 20.

When the application obtains the verifying codes 12, 14, the GPS unit 26 obtains a location data, and then the verifying codes 12, 14 and the location data are sent to the server 30 through the wireless transceiver 28.

When the server 30 receives the verifying codes 12, 14, it will compare the verifying codes 12, 14 from the mobile device 20 with the code combinations 32 stored in the server 30. If there is a code combination the same as the verifying codes 12, 14, it determines that the NFC tag 10 passes a code verification, and record the verifying codes 12, 14 and the location data in the server 30. When the code verification is successful, the verifying codes 12, 14 and the corresponding location data is recorded in the server 30, and a number of times of the NFC tag 10 is sensed is recorded in the server 30 as well. In the successful verification, the server 30 provides the following corresponding information, including product information, traceability information, introduction of manufacture, website address, and so on. If no code combination is found the same as the verifying codes 12, 14, it determines that the NFC tag 10 fails the code verification, and a fail result is sent back to the mobile device 20.

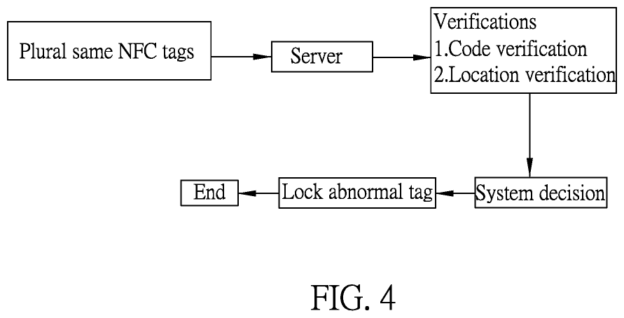

As shown in FIG. 4, it shows a verifying process when there are plural NFC tags 10, which have the same codes 12, 14, are sensed:

When two or more NFC tags 10 with the same verifying codes 12, 14 are sensed, and the verifying codes 12, 14 and the location data are transmitted to the server 30. These NFC tags 10 will pass the code verification since there is a code combination the same as the verifying codes 12, 14. Next, the server 30 performs a location verification.

In the location verification the location data are compared. It will determine the NFC tags 10 are fake while they have the same verifying codes 12, 14 and different location data, or it is the same NFC tag 10 being sensed for several times. Once the NFC tag 10 is determined as a fake tag, the corresponding code combination 32 is marked as an abnormal code combination, and any NFC tag 10 with the verifying codes 12, 14 the same as the abnormal code combination will be determined as a fake tag.

It may be an authentic NFC tag 10, which is sensed repeatedly. The number of times of the very NFC tag 10 being sensed could be adjusted by the system administrator to prevent this condition.

A message of the result of the code verification and the location verification will be transmitted to the mobile device 20 from the server 30, and shown on the display 29 to inform the consumer that the product is fake or authentic.

In conclusion, the present invention provides the NFC tag 10 and GPS signal for a two-stepped verification to prevent the problem of the NFC tag 10 being duplicated and the system cannot tell it is a fake one.

It must be pointed out that the embodiments described above are only some preferred embodiments of the present invention. All equivalent structures which employ the concepts disclosed in this specification and the appended claims should fall within the scope of the present invention.

What is claimed is:

1. An anti-counterfeiting system, comprising:
a Near Field Communication (NFC) tag attached to a product, wherein the NFC tag is stored with two verifying codes;
a mobile device having a processor, to which an NFC unit, a Global Positioning System (GPS) unit, a wireless transceiver, and a display are electrically connected, wherein the NFC unit reads the verifying codes of the NFC tag when the mobile device is close to the NFC tag; the GPS unit obtains a location data of the mobile device; and the wireless transceiver transmits the identification code, the encrypted code and the location data out; and
a server stored with a plurality of code combinations, wherein the server receives the verifying codes and the location data from the mobile device, compares the verifying codes with the code combinations, and record the verifying codes and the location data;
wherein the server transmits a message to the mobile device according to a comparison result of the verifying codes and the code combinations and a number of times of the verifying codes and the location data being recorded, and the mobile device shows the message on the display.

2. The anti-counterfeiting system of claim 1, wherein the verifying codes include an identification code and an encrypted code.

3. The anti-counterfeiting system of claim 1, wherein the message transmitted to the mobile device from the server includes product information, traceability information, and a website address.

4. The anti-counterfeiting system of claim 1, wherein the message indicates that the NFC tag is fake when no code combination is found the same as the verifying codes.

5. The anti-counterfeiting system of claim 1, wherein the message indicates that the NFC tag is fake when a code combination is found the same as the verifying codes and the location data is different from the location data, which had been recorded in the server.

6. The anti-counterfeiting system of claim 1, wherein the message indicates that the NFC tag is fake when a code combination is found the same as the verifying codes, the location data is the same as the location data, which had been recorded in the server, but the verifying codes and the location data had been recorded over a predetermined number of times.

7. The anti-counterfeiting system of claim 1, wherein the number of times of the verifying codes and the location data being recorded is adjustable by a system administrator.
